(19) United States
(12) Patent Application Publication
(10) Pub. No.: US 2006/0019230 A1
(43) Pub. Date: Jan. 26, 2006

(54) Method for collecting and organizing information for use in writing a book

(76) Inventor: Darlene Ghanem, Deerfield Beach, FL (US)

Correspondence Address: ROBERT M. DOWNEY, P.A., 601 SOUTH FEDERAL HIGHWAY, SUITE 300, BOCA RATON, FL, 33432, US

(21) Appl. No.: 11/187,463

(22) Filed: Jul. 22, 2005

Related U.S. Application Data
(60) Provisional application No. 60/590,482, filed on Jul. 23, 2004.

(51) Int. Cl. G09B 3/00

(52) U.S. Cl. 434/322

(57) ABSTRACT

A method for collecting and organizing information begins with presenting a group of respondents (children or adults) with a series of questions concerning one or more topics or issues. Respondents are also encouraged to express their feelings and opinions concerning any other issue. Respondents anonymously write their responses on a sheet of paper and anonymously deposit the sheet of paper into a box. Respondents may also enter their responses on a computer and anonymously transfer the responses to a database, via an Internet website. All received responses from respondents, whether received via internet or from the physical box, are compiled and stored in a central database. Next, the questions and responses are reviewed, organized and sorted according to categories. The organized responses and questions are used in the writing of a book relating to the topic addressed in the questions and respondent responses.

### BACKGROUND OF THE INVENTION

1. Field of the Invention

The present invention is directed to method of gathering and organizing information and, more particularly, to a method for collecting and organizing responses from targeted groups of individuals or from the general public for use in writing a book.

2. Discussion of the Related Art

Writing a book on virtually any subject typically requires the author(s) to conduct some research in order to acquire more extensive knowledge and information on the subject. In many instances, an author's research will involve searching various sources and reading relevant books, periodicals, records and other publications. Depending upon the subject and the nature of the book, the author may interview one or more persons to gain further insight on specific issues relating to a particular topic. Once the research is completed, the author will set out to write the book. For the most part, the content of the book is the author's own expression, based on his/her personal observations, conclusions and opinions gathered from the research. Thus, the content of the book can be, and often is, largely subjective as it is heavily influenced by the personal opinions and conclusions of the author.

There remains a need for a method of writing a book, the content of which, to a large extent, includes the expressions of many individuals, thereby providing a broad-based and more objective point of view. Moreover, there remains a need for a method of writing a book which includes the true feelings, opinions and observations of those who are the subject of the book (e.g. a book concerning children's emotions, wherein children are the subject of the book).

### SUMMARY OF THE INVENTION

The present invention is directed to a method which incorporates the direct input of many individuals, not just the author. The process starts by presenting groups of individuals (“Respondents”) with a set of questions relating to one or more issues or topics. The Respondents are encouraged to express their true feelings when answering the questions. Respondents are also encouraged to express their views, opinions, feelings and/or concerns on any other issue or topic they choose. To encourage both true and emotional expressions, a mechanism is provided which allows the Respondents to remain anonymous. Specifically, a physical box, known as The Voice Box™, is provided for anonymously receiving the responses. Respondents anonymously write their answers and/or other expressions on a sheet of paper and then deposit their responses through a slot in The Voice Box™. Alternatively, Respondents can enter their responses through a Virtual Voice Box™, by entering their responses via the Internet. More particularly, respondents can type their answers and expressions on a personal computer and then transfer their responses to a database via a website on the Internet.

Once the responses from Respondents are received, whether through The Voice Box™ or through The Virtual Voice Box™ via the Internet, they are compiled and stored in a central database. The stored responses are then organized and sorted into categories for subsequent use in the writing of a book which addresses on or more subjects relating to the collected responses.

### BRIEF DESCRIPTION OF THE DRAWINGS

For a fuller understanding of the nature of the present invention, reference should be made to the following detailed description taken in conjunction with the accompanying drawings in which:

FIG. 1 is a schematic diagram illustrating the sequence of steps of the method of the present invention.

### DETAILED DESCRIPTION OF THE PREFERRED EMBODIMENT

The method of the present invention collects and organizes information gathered from the responses of many individuals, for subsequent use in writing a book.

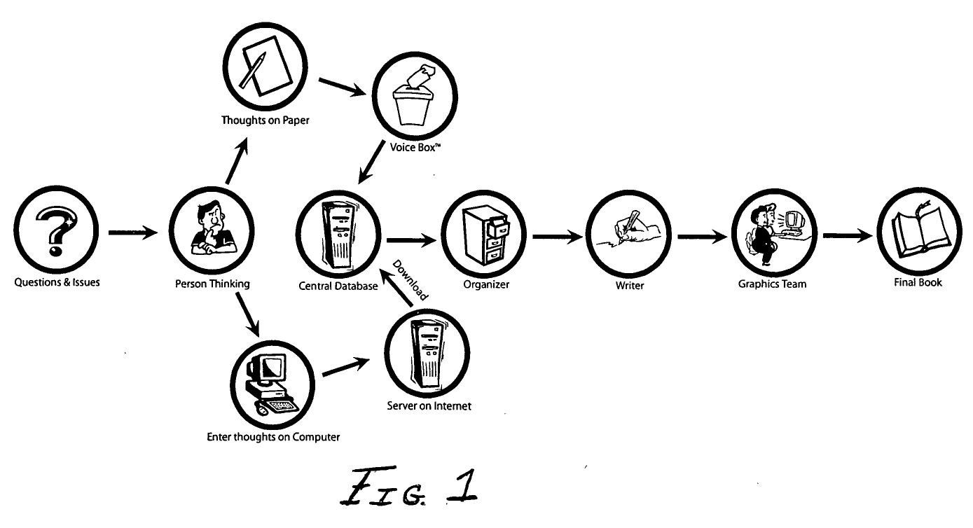

Referring to FIG. 1, the method of the present invention begins by presenting groups of individuals (“Respondents”) with a set of questions and/or issues prompting the Respondent to reply. Specifically, the Respondents are encouraged to express their true feelings when answering one or more questions. The Respondents are also encouraged to express their views, opinions, feelings and/or concerns on any other issue or topic they choose. The Respondents may be taken from a targeted group, such as children or adults. The Respondents may also be targeted in groups based on race, religion, location or other demographics. Alternatively, the Respondents may be simply members of the general public of all age, race, religion and income levels throughout a community, state, region or country.

To encourage real (true) and emotional expressions, a mechanism is provided which allows Respondents to remain anonymous. Specifically, Respondents anonymously write their answers, thoughts, opinions and other expressions on a sheet of paper and then deposit this sheet of paper through a slot in a closed box known as The Voice Box™. Preferably, one or more Voice Box™ units are placed at locations (e.g. schools, libraries, gyms, community centers, etc.) where target Respondents tend to visit. The method may involve placement of just one of The Voice Box™ units or as many as hundreds of The Voice Box™ units. Alternatively, Respondents can enter their answers, thoughts, opinions and other expressions on a computer for transfer (uploading) to a server on the Internet. More particularly, Respondents can visit a website on the Internet which presents the questions and issues and prompts a reply.

All responses from Respondents, whether received through The Voice Box™ or through The Virtual Voice Box™ via the Internet, are compiled and stored in a central database. All information, including questions and responses from Respondents stored on the central database is subsequently organized and sorted according to particular topics, issues or other categories. The organized information is then used by one or more authors to write a book addressing the subject relating to the organized information. A graphics team works in conjunction with the one or more authors to provide illustrations and other graphics which correspond to the written text. The combined work of the author and graphics team produces the final product, which is a book.

While the present invention has been shown and described in accordance with a preferred and practical embodiment thereof, it is recognized that departures from the instant disclosure are contemplated within the spirit and scope of the present invention.

What is claimed is:

1. A method for writing a book comprising the steps of:
presenting a group of respondents with a series of questions concerning one or more topics;
requesting the respondents to anonymously enter their responses to the series of questions into a device for anonymous storage and collection;
reviewing the respondents' collected responses;
establishing predefined categories based on a review of the respondents' collected responses;
sorting and organizing the respondents' collected responses to match each of the collected responses with one of the predefined categories; and
arranging the respondents' responses into chapters of a book.

2. The method as recited in claim 1 comprising the further steps of:
inviting the group of respondents to anonymously express their personal views, opinions and feelings concerning any topic; and
requesting the respondents to anonymously enter their expressed personal views, opinions and feelings into the device for storage, collection, review, sorting and organizing along with the respondents' collected responses to the series of questions for arrangement into the chapters of the book.

3. The method as recited in claim 2 wherein the device for anonymous storage and collection is a box with a slot opening for receiving sheets of paper containing the written responses of the respondents.

4. The method as recited in claim 2 wherein the device for anonymous storage and collection is a computer connected to the Internet, a server on the Internet and a central data base connected to and communicating with the server.

5. The method as recited in claim 1 further comprising the step of:
writing original text to be included in one or more of the chapters, the original text corresponding with the topic and predefined category associated with the sorted and organized collected responses of the respondents.

6. The method as recited in claim 5 comprising the further steps of:
creating graphics relating to the one or more topics and predefined categories; and
arranging the graphics with the arranged responses of the respondents and the original text for inclusion in one or more chapters of the book.

7. A method for writing a book comprising the steps of:
presenting a group of respondents with a series of questions concerning one or more topics;
requesting the respondents to anonymously respond to the series of questions;
receiving the respondents' responses in a device for anonymous collection and storage;
retrieving the collected and stored responses;
reviewing the retrieved responses of the respondents;
sorting and organizing the collected responses; and
arranging the responses into chapters of a book.

8. The method as recited in claim 7 comprising the further steps of:
inviting the group of respondents to anonymously express their personal views, opinions and feelings concerning any topic; and
requesting the respondents to anonymously enter their expressed personal views, opinions and feelings into the device for collection, storage, review, sorting and organizing along with collected responses of the respondents for arrangement into the chapters of the book.

9. The method as recited in claim 8 wherein the device for anonymous entry, collection and storage is slips of paper for writing the responses, expressed personal views, opinions and feelings of the respondents thereon, and a box with a slot opening for anonymously receiving the slips of paper containing the written responses, expressed personal views, opinions and feelings of the respondents.

10. The method as recited in claim 8 wherein the device for anonymous entry, collection and storage is a personal computer connected to the Internet, a server on the Internet and a central computer database connecting to and communicating with the server on the Internet.

11. The method as recited in claim 7 further comprising the step of:
writing original text relating to the one or more topics and the reviewed responses of the respondents for inclusion in the book.

12. The method as recited in claim 7 further comprising the steps of:
creating graphics relating to the one or more topics, and arranging the graphics with the arranged responses of the respondents for inclusion in the book.
